(19) United States
(12) Patent Application Publication
(10) Pub. No.: US 2010/0037288 A1
(43) Pub. Date: Feb. 11, 2010

(54) Inherited Access Authorization to a Social Network

(75) Inventors: Theodore R. Carraher, Raleigh, NC (US); Jason A. Cox, Raleigh, NC (US); Lydia M. Do, Research Triangle Park, NC (US); Michael L. Karm, Cedar Park, TX (US)

Correspondence Address: CANTOR COLBURN LLP - IBM RESEARCH TRIANGLE PARK, 20 Church Street, 22nd Floor, Hartford, CT, 06103, US

(73) Assignee: INTERNATIONAL BUSINESS MACHINES CORPORATION, Armonk, NY (US)

(21) Appl. No.: 12/357,834

(22) Filed: Jan. 22, 2009

Related U.S. Application Data
(63) Continuation-in-part of application No. 12/186,972, filed on Aug. 6, 2008, now abandoned.

(51) Int. Cl. H04L 9/32

(52) U.S. Cl. 726/1; 726/4

(57) ABSTRACT

A method for access authorization via inheritance to information of a first registered user on a social network comprises defining authorization criteria for the first registered user; receiving first verification data from a requester, wherein the requester comprises one of a second registered user or a non-registered user; determining if the first verification data satisfies the authorization criteria, and in the event the first verification data satisfies the authorization criteria, extending inherited access authorization to the requester in the event the requester is the non-registered user, and extending inherited access authorization to a contact of the requestor in the event the requestor is the second registered user.

### CROSS-REFERENCE TO RELATED APPLICATIONS

This application is a continuation-in-part of U.S. application Ser. No. 12/186,972, filed on Aug. 6, 2008.

### BACKGROUND

This invention relates generally to social networks, and particularly to extending inherited access authorization to information of a registered user on a social network.

Accessing social networks, such as social networking websites, e.g., via computing devices such as cell phones, personal computers, etc., is a popular way of interacting and sharing information among social contacts such as friends, family, co-workers, etc. Some example social networks may include but are not limited to Facebook, MySpace, or Friendster. A registered user of a social network may authorize contacts to access information, which may include content or data, of the registered user on the social network (e.g., via one or more web pages managed by the user). However, the contacts typically need to be registered with the social network (e.g., by providing requested registration information) in order to access the information of the registered user. Furthermore, contacts may need to manually submit information (e.g., user name, password, etc.) by, for example, logging in to the social network, for verifying authorization to access to the information of the registered user.

### BRIEF SUMMARY

Inherited access authorization to information of a registered user on a social network is provided. An exemplary embodiment of a method for access authorization via inheritance to information of a first registered user on a social network comprises defining authorization criteria for the first registered user; receiving first verification data from a requester, wherein the requester comprises one of a second registered user or a non-registered user; determining if the first verification data satisfies the authorization criteria, and in the event the first verification data satisfies the authorization criteria, extending inherited access authorization to the requestor in the event the requestor is the non-registered user, and extending inherited access authorization to a contact of the requester in the event the requester is the second registered user.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE SEVERAL VIEWS OF THE DRAWINGS

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a block diagram illustrating an example of a system including an exemplary computing device configured to authorize access to social networks.

FIG. 2 is a flow diagram illustrating an example of a method of authorizing access by inheritance to a social network, which is executable, for example, on the exemplary computing device of FIG. 1.

FIG. 3 illustrates an example system for authorizing access by inheritance to an online social network which may incorporate, for example, the exemplary computing device of FIG. 1.

The detailed description explains the preferred embodiments of the invention, together with advantages and features, by way of example with reference to the drawings.

### DETAILED DESCRIPTION

According to exemplary embodiments of the invention described herein, inherited authorization to information on social networks is provided. In accordance with such exemplary embodiments, a second registered user, who is an authorized contact of a first registered user, may transmit inherited access authorization to view information of the first registered user on the social network to a contact of the second registered user (e.g. a third party). In another exemplary embodiment, when a non-registered user requests access from a first registered user on a social network, the request contains information regarding the relationship between the non-registered user and an authorized contact of the first registered user. The relationship between the non-registered user and the authorized contact may involve 0 or more degrees of separation. When considering the request, the first registered user may use the knowledge of the relationship of the requester to an authorized contact, including the degree of separation, to make a decision regarding whether to grant the requester access to the first registered user's information. This process may be automated if the first registered user configures their profile to automatically grant access to requestors, with authorization levels pre-determined according to degrees of separation, upon verification of the authenticity of the relationship of a requester to an authorized contact. Thus, inherited authorization may be granted to registered or non-registered users of the social network.

A registered user of a social network may define authorization criteria that may be used to determine whether to grant contacts, who may be registered or non-registered users of the social network at varying degrees of separation from the registered user, inherited authorization to view the registered user's information on the social network. The inherited authorization may extend to contacts at any number of degrees of separation; the permitted maximum degree of separation may be specified in the authorization criteria. Direct contacts of the registered user may have a degree of separation of 0, contacts of the direct contacts may have a degree of separation of 1, and contacts of the contacts of the direct contacts may have a degree of separation of 2, and so on. For example, if the authorization criteria specifies an allowed degree of separation of 2, contacts of contacts of direct contacts may be permitted to access to the registered user's information on a social network.

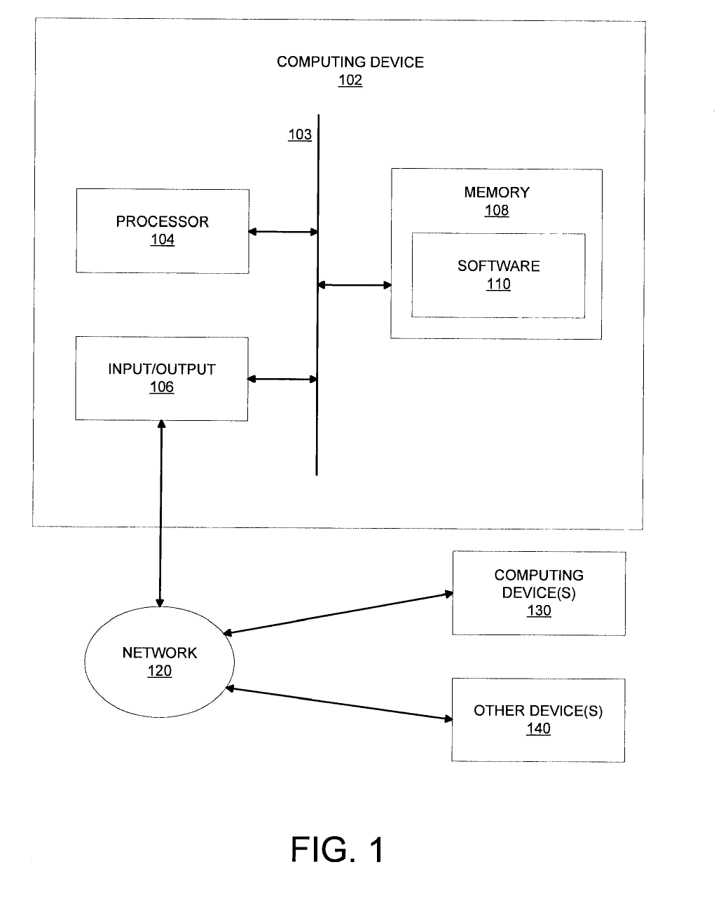

Turning now to the drawings in greater detail, wherein like reference numerals indicate like elements, FIG. 1 illustrates an example of a system 100 including an exemplary computing device 102 configured to authorize access to a social network. In this regard, computing device 102 may include any device that is capable of receiving, transmitting, and processing data, such as a cell phone, a computer, etc. In addition to computing device 102, exemplary system 100 includes network 120, computing device(s) 130, and other device(s) 140. Network 120 connects computing device 102, computing device(s) 130, and other device(s) 140 and may include one or more wide area networks (WANs) and/or local area networks (LANs) such as the Internet, intranet(s), cellular network(s), and/or wireless communications network(s). Computing device(s) 130 may include one or more other computing devices, e.g., that are similar to computing device 102 and which, e.g., may operate as a server device, client device, etc. within system 100. Other device(s) 140 may include one or more other computing devices that provide data storage and/or other computing functions. Computing device 102, computing device(s) 130, and other device(s) 140 are in communication via network 120, e.g., to communicate data between them.

Exemplary computing device 102 may include a processor 104, input/output component(s) 106, and a memory 108, which may be in communication via a bus 103. Processor 104 may include multiple (e.g., two or more) processors, which may, e.g., implement pipeline processing, and may also include cache memory (“cache”) and controls (not depicted). The cache may include multiple cache levels (e.g., L1, L2, etc.) that are on or off-chip from processor 104 (e.g., an L1 cache may be on-chip, an L2 cache may be off-chip, etc.). Input/output component(s) 106 may include one or more components that facilitate local and/or remote input/output operations to/from computing device 102, such as a display, keyboard, modem, network adapter, ports, etc. (not depicted). Memory 108 includes software 110 configured to authorize access by inheritance to social networks, which is executable, e.g., by computing device 102 via processor 104. Memory 108 may include other software, data, etc. (not depicted).

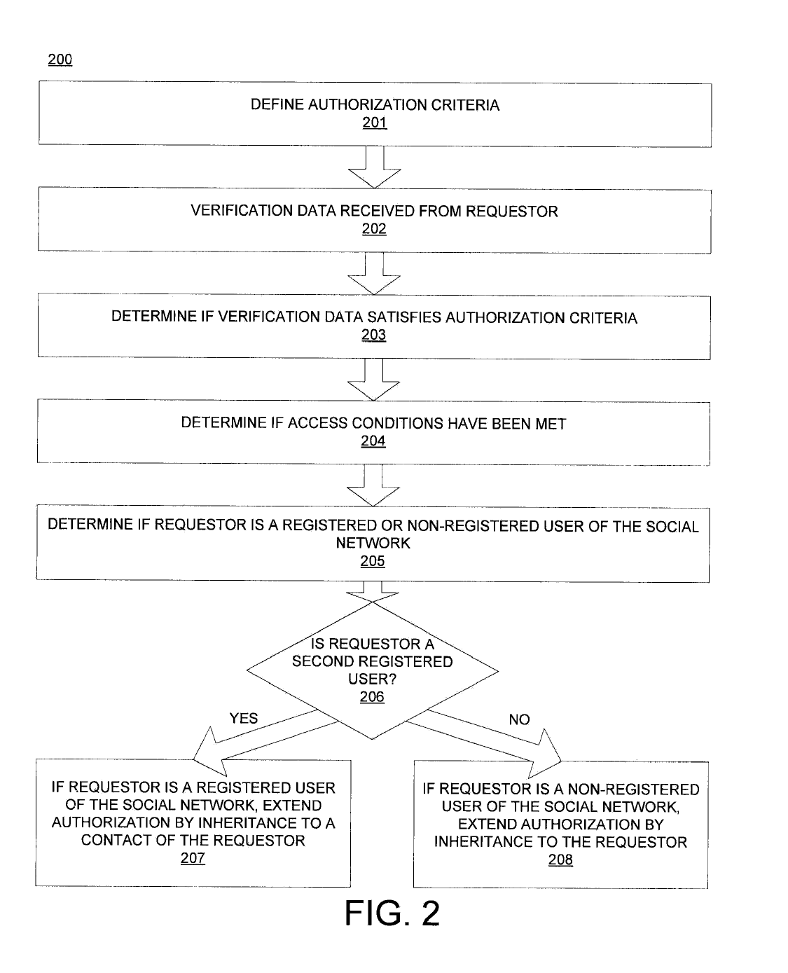

FIG. 2 illustrates an example of a method 200 to authorize access to a social network, which is executable, for example, on an exemplary computing device 102 of FIG. 1 (e.g., as a computer program product). In block 201, authorization criteria is defined (e.g., via computing device 102) for a first registered user of a social network. In some embodiments, the authorization criteria may be defined by the first registered user, or the authorization criteria may be a default authorization criteria defined by the social network. The authorization criteria defines verification data. In some embodiments, the verification data may include but is not limited to an access token, an identity of a requester (e.g., a name, alias, etc.), an identity of a first registered user on a social network, or a relationship (which may include a degree of separation) of a requester to a first registered user. The authorization criteria may further specify a maximum degree of separation to which authorization by inheritance may be extended, i.e., contacts of authorized contacts, contacts of contacts of authorized contacts, etc.

In block 202, a requestor provides verification data (e.g. transmits, gives access to, etc.), via another computing device 130, to the social network in order to establish access authorization to the information of the first registered user. In block 203, it is determined whether the authorization criteria is satisfied by the verification data provided by requester. If the authorization criteria is satisfied, then, in block 204, it is determined if access conditions have been met. In block 205, it is determined if the requester is a registered or non-registered user of the social network. In block 206, if the requester is a second registered user of the social network, flow proceeds to block 207 and inherited authorization is extended to a contact of the requestor, allowing the contact of the requester to access information of the registered user on the social network. The contact's inherited authorization may be subject to an access condition. If, in block 206, the requester is not a second registered user of the social network, then flow proceeds to block 208 and inherited authorization is extended to the requester. The requestor's inherited authorization may also be restricted based on an access condition, which is discussed below.

An access condition may be specified in the authorization criteria. The access condition may specify a period of time during which an inherited authorization is valid, or a type of information of the registered user that is available via the inherited authorization. The access condition for an inherited authorization granted for a lower degree of separation from a first registered user may differ from an access condition for an inherited authorization granted for a higher degree of separation from a first registered user. For example, a contact having a degree of separation of 0 from a first registered user in a social network may be a direct contact and authorized to view all of the information of the first registered user; a contact having a degree of separation of 1 from a first registered user may be authorized to view only status, comments, and photos of the first registered user; and a contact having a degree of separation of 2 from a first registered user may be authorized to view only photos. The access conditions for each degree of separation may be configured by the first registered user, or may be a default set in the social network. When a requester is a second registered user of a social network with a degree of separation of 0 from a first registered user, the access condition for a contact of the requestor may in some embodiments be further restrained by the second registered user in addition to the access conditions set by the first registered user or set by default by the social network. The second registered user may, in some embodiments, only authorize access by their contacts to the information of a first registered user, or a subset of the information, that the second registered user is themselves authorized to access. If authorization criteria has been verified and access conditions are met to view the information of a first registered user, then the viewer of this information is considered an authorized contact of the first registered user. This creates a chain of established authorized contacts to a first registered user by proxy. In some embodiments, if a contact no longer meets the authorization criteria or access conditions to the information of a first registered user, then the chain is considered broken for the contact and for any of his/her contacts who may have previously had access to the information of the first registered user.

In some embodiments, authorization by inheritance may be passed via an access token that links a requester to an authorized contact. The access token may include but is not limited to a design code, metadata, or digital fingerprint information. The access token may be included in the verification data provided by a requester; a valid access token satisfies the authorization criteria. The access token may specify an access condition for the inherited authorization; the access condition may in some embodiments be defined by the authorized contact providing the access token, or the access condition may be defined by the authorization criteria. If the access condition is defined by the authorized contact, the access condition may only authorize access to the information, or a subset of the information, that the authorized contact is authorized to access.

In other embodiments, an authorized contact may provide a list of the authorized contact's contacts to the social network; the list of authorized contacts may be included in the authorization criteria. A requester may include an identity of the requester in their verification data, which may be used to satisfy the authorization criteria. The access granted to listed contacts may also be subject to an access condition, which may in some embodiments be defined by authorized contact. If the access condition is defined by the authorized contact, the access condition may only authorize access to the information, or a subset of the information, that the authorized contact is authorized to access.

In some embodiments, the social network may allow one or more hooks into the environment (e.g., via plug-ins, guest accounts tied to a first registered user, etc.) that may provide a requester with a way to make information of a first registered user available to contacts. In such embodiments, authorizing access to a social network may be executed via an application or framework that is extended to allow handshaking protocol between the registered user and authorized non-registered users, e.g., outside of the social network environment. For example, an intermediary website can be used to verify the authorization of a contact, and may ghost authenticate the authorization to the social network.

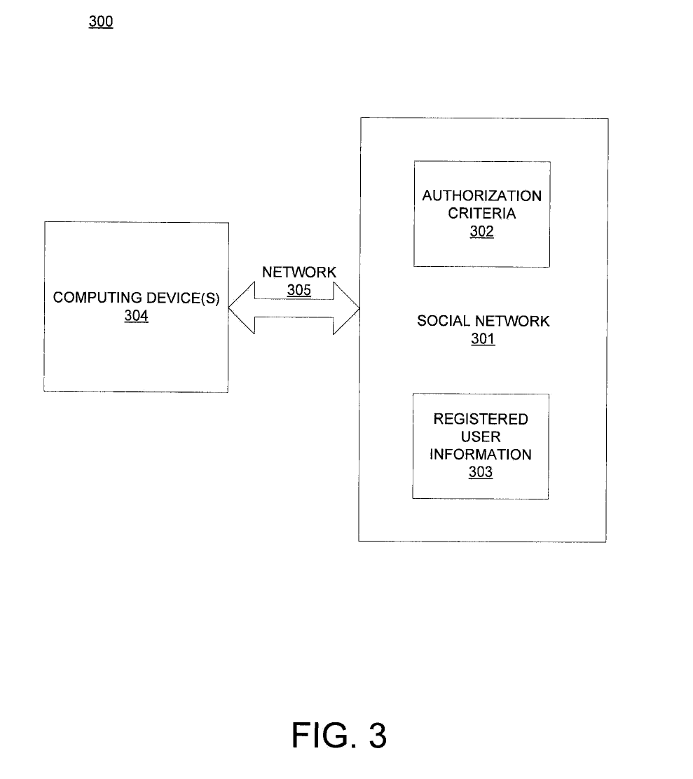

FIG. 3 illustrates an embodiment of a system 300 for authorizing access by inheritance to an online social network, which may include, for example, the exemplary computing device shown in FIG. 1. System 300 may comprise a plurality of computing devices 304 in communication with a social network 301 via network 305. A requestor provides verification data to social network 301 via a computing device 304 and network 305. If the verification data satisfies authorization criteria 302, access by inheritance may be granted to the information of a first registered user 303; the information 303 may be viewed on a computing device 304 via network 305. The access by inheritance may be granted to the requestor if the requestor is a non-registered user of the social network, or to a contact of the requestor if the requestor is a second registered user of the social network.

Exemplary system 100 and computing device 102 are illustrated and described with respect to various components, modules, etc. for exemplary purposes. It should be understood that other variations, combinations, or integrations of such elements that provide the same features, functions, etc. are included within the scope of embodiments of the invention.

The flowchart and/or block diagram(s) in the Figure(s) described herein illustrate the architecture, functionality, and/or operation of possible implementations of systems, methods, and/or computer program products according to various embodiments of the present invention. In this regard, each block in a flowchart or block diagram may represent a module, segment, or portion of code, which comprises one or more executable instructions for implementing the specified logical function(s). It should also be noted that, in some alternative implementations, the functions noted in a flowchart or block diagram may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in a flowchart or block diagram can be implemented by special purpose hardware-based systems that perform the specified functions or acts, or combinations of special purpose hardware and computer instructions.

The terminology used herein is for the purpose of describing exemplary embodiments and is not intended to be limiting of the present invention. As used herein, the singular forms “a”, “an”, and “the” are intended to include the plural forms as well, unless the context clearly indicates otherwise. It will be further understood that the terms “comprises”, “comprising”, “includes”, or “including” when used in this specification, specify the presence of stated features, integers, steps, operations, elements, and/or components, but do not preclude the presence or addition of one or more other features, integers, steps, operations, elements, components, and/or groups thereof

The corresponding structures, materials, acts, and equivalents of any means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The exemplary embodiment(s) were chosen and described in order to explain the principles of the present invention and the practical application, and to enable others of ordinary skill in the art to understand the present invention for various embodiments with various modifications as are suited to the particular use contemplated.

As will be appreciated by one skilled in the art, the present invention may be embodied as a system, method, and/or computer program product. Accordingly, the present invention may take the form of an entirely hardware embodiment, an entirely software embodiment (including firmware, resident software, micro-code, etc.), and/or or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, land line, optical fiber cable, RF, etc.

Computer program code for carrying out operations of the present invention may be written in any combination of one or more programming languages, including an object oriented programming language such as Java, Smalltalk, C++, or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN), a cellular network, or a wide area network (WAN), or the connection may be made to an external computer (for example, through the Internet using an Internet Service Provider).

The present invention is described herein with reference to flowchart illustrations and/or block diagrams of methods, apparatus (systems), and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block(s).

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block(s). The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide processes for implementing the functions/acts specified in the flowchart and/or block diagram blocks.

While exemplary embodiments of the invention have been described, it will be understood that those skilled in the art, both now and in the future, may make various improvements and enhancements which fall within the scope of the claims that follow. These claims should be construed to maintain the proper protection for the invention first described.

1. A method for access authorization via inheritance to information of a first registered user on a social network, the method comprising:
defining authorization criteria for the first registered user;
receiving first verification data from a requester, wherein the requestor comprises one of a second registered user or a non-registered user;
determining if the first verification data satisfies the authorization criteria, and in the event the first verification data satisfies the authorization criteria, extending inherited access authorization to the requester in the event the requester is the non-registered user, and extending inherited access authorization to a contact of the requestor in the event the requester is the second registered user.

2. The method of claim 1, wherein extending inherited access authorization comprises allowing access to information of the first registered user on the social network.

3. The method of claim 2, further comprising restricting the inherited access authorization based on an access condition.

4. The method of claim 3, wherein the access condition specifies a period of time during which inherited access authorization is valid.

5. The method of claim 3, wherein the access condition specifies a type of information of the first registered user that may be accessed.

6. The method of claim 3, wherein the access condition is determined based on a degree of separation from the first registered user.

7. The method of claim 3, wherein the access condition is determined by the requester in the event the requester is the second registered user, and the access condition defines a subset of the information of the first registered user that the requestor is authorized to access.

8. The method of claim 1, wherein the first verification data comprises an access token.

9. The method of claim 1, wherein the authorization criteria comprises a list of contacts of a contact of the first registered user.

10. The method of claim 9, wherein the list of contacts of the contact comprises an identity of the requester, and the verification data is determined to satisfy the authorization criteria if the verification data comprises the identity of the requestor.

11. The method of claim 1, wherein the authorization criteria comprises an identity of the first registered user, and the verification data is determined to satisfy the authorization criteria if the verification data comprises the identity of the first registered user.

12. The method of claim 1, wherein the authorization criteria is defined by the first registered user.

13. The method of claim 1, wherein the authorization criteria is a default authorization criteria defined by the social network.

14. The method of claim 1, wherein the verification data comprises a relationship of the requester to the first registered user.

15. The method of claim 1, wherein the verification data comprises a relationship of the requester to a contact of the first registered user.

16. The method of claim 1, wherein the authorization criteria comprises a maximum permitted degree of separation for extension of authorization by inheritance, and the verification data comprises the degree of separation of the requester from the first registered user.

17. The method of claim 16, wherein the verification data is determined to satisfy the authorization criteria if the degree of separation of the requestor from the first registered user is less than or equal to the maximum permitted degree of separation.

18. A computer program product comprising a computer readable storage medium containing computer code that, when executed by a computer, implements a method for accessing information of a registered user on a social network, wherein the method comprises:
defining authorization criteria for the first registered user;
receiving first verification data from a requestor, wherein the requestor comprises one of a second registered user or a non-registered user;
determining if the first verification data satisfies the authorization criteria, and in the event the first verification data satisfies the authorization criteria, extending inherited access authorization to the requester in the event the requester is the non-registered user, and extending inherited access authorization to a contact of the requestor in the event the requester is the second registered user.

19. A system for access authorization via inheritance to information of a first registered user on a social network, the system comprising:
a network configured to transmit first verification data from a requestor to the social network, wherein the requester comprises one of a second registered user or a non-registered user; and
a social network, the social network comprising authorization criteria for the first registered user, the social network being configured to determine if the first verification data satisfies the authorization criteria, and in the event the first verification data satisfies the authorization criteria, extending inherited access authorization to the requestor in the event the requestor is the non-registered user, and extending inherited access authorization to a contact of the requestor in the event the requestor is the second registered user.
